(19) United States
(12) Patent Application Publication
(10) Pub. No.: US 2025/0381920 A1
(43) Pub. Date: Dec. 18, 2025

(54) VEHICULAR DEVICE ATTACHING TOOL AND VEHICULAR DEVICE ATTACHING STRUCTURE

(71) Applicant: YOKOWO CO., LTD., Tokyo (JP)

(72) Inventor: Tsugio YAMAMOTO, Tokyo (JP)

(73) Assignee: YOKOWO CO., LTD., Tokyo (JP)

(21) Appl. No.: 18/878,652

(22) PCT Filed: Jun. 1, 2023
(86) PCT No.: PCT/JP2023/020502

§ 371 Date: Dec. 24, 2024

(30) Foreign Application Priority Data
Jun. 28, 2022 (JP) 2022-104099

(51) Int. Cl. B60R 11/02; E05B 19/00

(52) U.S. Cl. CPC B60R 11/02; E05B 19/00

(57) ABSTRACT

A vehicular device attaching tool for attaching a vehicular device, which accommodates an electronic key of a vehicle, to the vehicle, includes: a fixing portion fixed to the vehicle; and a coupling portion extending from the fixing portion and coupled to the vehicular device. The coupling portion is formed with a center hole through which a first fastener is inserted, and an angle adjustment hole that has a predetermined length and through which a second fastener is inserted such that a fastening position is changeable.

### CROSS-REFERENCE TO RELATED APPLICATIONS

This application is a national stage application, pursuant to 35 U.S.C. § 371, of International Patent Application No. PCT/JP2023/020502, filed Jun. 1, 2023, which claims priority to Japanese Patent Application No. 2022-104099, filed Jun. 28, 2022, the entire contents of each are incorporated herein by reference.

### TECHNICAL FIELD

The present invention relates to a vehicular device attaching tool and a vehicular device attaching structure.

### BACKGROUND ART

As usage forms of an automobile, there is a form in which a plurality of persons share one or a plurality of vehicles. This corresponds to car sharing and rental cars. Hereinafter, such usage forms are collectively referred to as “sharing”.

In sharing, handling of a key for using a vehicle to be shared is important. For example, Patent Literature 1 discloses a technique of a vehicular device that accommodates an electronic key available for sharing or the like.

### CITATION LIST

### Patent Literature

Patent Literature 1: Japanese Patent No. 6710832

### SUMMARY OF INVENTION

### Technical Problem

However, no techniques have been known for a vehicular device attaching tool and a vehicular device attaching structure for fixing a vehicular device, which accommodates an electronic key, to a vehicle.

One example of an object of the present invention is to provide a vehicular device attaching tool and a vehicular device attaching structure for fixing a vehicular device, which accommodates an electronic key, to a vehicle. Other objects of the present invention will become apparent based on the description of the present specification.

### Solution to Problem

An aspect of the present invention is a vehicular device attaching tool for attaching a vehicular device, which accommodates an electronic key of a vehicle, to the vehicle, the vehicular device attaching tool includes a fixing portion fixed to the vehicle; and a coupling portion extending from the fixing portion and coupled to the vehicular device, in which the coupling portion is formed with a center hole through which a first fastener is inserted, and an angle adjustment hole that has a predetermined length and through which a second fastener is inserted such that a fastening position is changeable.

An aspect of the present invention is a vehicular device attaching structure for attaching a vehicular device, which accommodates an electronic key of a vehicle, to the vehicle, the vehicular device attaching structure includes an attaching tool including a fixing portion fixed to the vehicle and a coupling portion extending from the fixing portion and coupled to the vehicular device; and a fastening portion fastened to the coupling portion formed in the vehicular device, in which the coupling portion is arranged on two opposing surfaces of the vehicular device, and the fastening portion is configured to allow fastening to the coupling portion even in a state in which a relation between the coupling portion and the two opposing surfaces of the vehicular device is relatively changed.

According to the above aspects of the present invention, it is possible to provide a vehicular device attaching tool and a vehicular device attaching structure for fixing a vehicular device, which accommodates an electronic key, to a vehicle.

### BRIEF DESCRIPTION OF DRAWINGS

FIG. 1 is a schematic diagram showing a system configuration example of a sharing system 3 using an electronic key operation device 100 according to a first embodiment.

FIG. 2 is a schematic diagram conceptually showing an operation of the electronic key operation device 100 according to one embodiment.

FIG. 3 is a schematic perspective view showing one embodiment in which an electronic key 200 accommodated in an electronic key accommodation case 300 is accommodated in an electronic key accommodation portion 110 of the electronic key operation device 100.

FIG. 4 is a schematic perspective view schematically showing details of the electronic key accommodation case 300 used in the embodiment of FIG. 3 in a state in which the electronic key 200 is accommodated.

FIG. 5A is a schematic perspective view showing an overview of the electronic key operation device 100 from a front side, a top side, and a right side.

FIG. 5B is a schematic perspective view showing an overview of the electronic key operation device 100 from the front side, a lower side, and a left side.

FIG. 6A is a front view showing an overview of the electronic key operation device 100.

FIG. 6B is a left-side view showing an overview of the electronic key operation device 100.

FIG. 6C is a right-side view showing an overview of the electronic key operation device 100.

FIG. 7A is a perspective one-side cross-sectional view of a right side surface 130r showing a structural example of a fastening portion.

FIG. 7B is a perspective one-side cross-sectional view in which a metal fixture 182 is enlarged.

FIG. 8A is a schematic perspective view showing a structure of a vehicular device attaching tool 400.

FIG. 8B is a schematic top view showing the structure of the vehicular device attaching tool 400.

FIG. 8C is a schematic side view showing the structure of the vehicular device attaching tool 400.

FIG. 8D is a schematic front view showing the structure of the vehicular device attaching tool 400.

FIG. 9A is a schematic perspective view showing a state in which the vehicular device attaching tool 400 is attached on a top surface 130t side of the electronic key operation device 100.

FIG. 9B is a schematic perspective view showing a state in which the vehicular device attaching tool 400 is attached on a bottom surface 130b side of the electronic key operation device 100.

FIG. 10A is a schematic side view showing angle adjustment of the vehicular device attaching tool 400 with respect to the electronic key operation device 100, and shows a case in which the electronic key operation device 100 is held parallel to a fixing portion 401.

FIG. 10B is a schematic side view showing the angle adjustment of the vehicular device attaching tool 400 with respect to the electronic key operation device 100, and shows a case in which the electronic key operation device 100 is held by being tilted at an angle θ with respect to the fixing portion 401.

FIG. 11A is a diagram illustrating an insertion and removal operation of the electronic key accommodation case 300 when the electronic key operation device 100 is mounted on a vehicle by using the vehicular device attaching tool 400, and shows a state in which a glovebox 620 is closed.

FIG. 11B is a diagram illustrating the insertion and removal operation of the electronic key accommodation case 300 when the electronic key operation device 100 is mounted on the vehicle by using the vehicular device attaching tool 400, and shows a state in which the glovebox 620 is opened.

FIG. 12A is a schematic perspective view showing a structure of a vehicular device attaching tool 410 according to a second embodiment.

FIG. 12B is a schematic top view showing the structure of the vehicular device attaching tool 410 according to the second embodiment.

FIG. 12C is a schematic side view showing the structure of the vehicular device attaching tool 410 according to the second embodiment.

FIG. 12D is a schematic front view showing the structure of the vehicular device attaching tool 410 according to the second embodiment.

FIG. 13A is a schematic perspective view showing a structure of a vehicular device attaching tool 420 according to the second embodiment.

FIG. 13B is a schematic top view showing the structure of the vehicular device attaching tool 420 according to the second embodiment.

FIG. 13C is a schematic side view showing the structure of the vehicular device attaching tool 420 according to the second embodiment.

FIG. 13D is a schematic front view showing the structure of the vehicular device attaching tool 420 according to the second embodiment.

FIG. 14A is a schematic perspective view showing a state in which the vehicular device attaching tools 410 and 420 are attached on the top surface 130t side of the electronic key operation device 100.

FIG. 14B is a schematic perspective view showing a state in which the vehicular device attaching tools 410 and 420 are attached on the bottom surface 130b side of the electronic key operation device 100.

FIG. 15A is a schematic side view showing angle adjustment of the vehicular device attaching tools 410 and 420 with respect to the electronic key operation device 100, and shows a case in which the electronic key operation device 100 is held parallel to a fixing portion 421.

FIG. 15B is a schematic side view showing the angle adjustment of the 10 vehicular device attaching tools 410 and 420 with respect to the electronic key operation device 100, and shows a case in which the electronic key operation device 100 is held by being tilted at an angle θ with respect to the fixing portion 421.

FIG. 16A is a diagram illustrating the insertion and removal operation of the electronic key accommodation case 300 when the electronic key operation device 100 is mounted on the vehicle by using the vehicular device attaching tools 410 and 420, and shows a state in which a glovebox 640 is closed.

FIG. 16B is a diagram illustrating the insertion and removal operation of the electronic key accommodation case 300 when the electronic key operation device 100 is mounted on the vehicle by using the vehicular device attaching tools 410 and 420, and shows a state in which the glovebox 640 is opened.

FIG. 17A is a schematic perspective view showing a structure of a vehicular device attaching tool 430 according to a third embodiment.

FIG. 17B is a schematic perspective view showing a structure of a vehicular device attaching tool 440 according to the third embodiment.

FIG. 17C is a schematic perspective view showing a structure of a vehicular device attaching tool 450 according to the third embodiment.

FIG. 18A is a diagram illustrating a vehicular device attaching structure using the vehicular device attaching tools 400 and 420 according to a fourth embodiment, and shows a state in which the glovebox 620 is closed.

FIG. 18B is a diagram illustrating the vehicular device attaching structure using the vehicular device attaching tools 400 and 420 according to the fourth embodiment, and shows a state in which the glovebox 620 is opened.

FIG. 19A is a diagram illustrating a vehicular device attaching structure using the vehicular device attaching tool 400 and a supporter 460 according to a fifth embodiment, and shows a state in which the glovebox 620 is closed.

FIG. 19B is a diagram illustrating the vehicular device attaching structure using the vehicular device attaching tool 400 and the supporter 460 according to the fifth embodiment, and shows a state in which the glovebox 620 is opened.

FIG. 20 is a schematic diagram showing an example in which an elastically deformable vibration absorbing portion is used as the supporter 460.

### DESCRIPTION OF EMBODIMENTS

The present invention will be specifically described with reference to the following embodiments, but the present invention is not limited thereto. When there is no particular detailed reference to each device, mechanism, means, and the like described in the present specification, those skilled in the art can use known mechanical devices, mechanisms, means, and the like. The respective embodiments can be combined based on ordinary knowledge by those skilled in the art, and configurations not specifically described in the respective embodiments can have the same configurations as the other embodiments or configurations suitable for the embodiments. In a cross-sectional view, a cross section of each member is represented by various oblique lines for easy discrimination from other members, but a difference in oblique lines does not represent a difference in material, shape, or the like of the member. Also in a perspective view, each member is represented by a color or a dot for easy discrimination from other members, but this difference does not represent a difference in material, shape, or the like of the member.

### First Embodiment

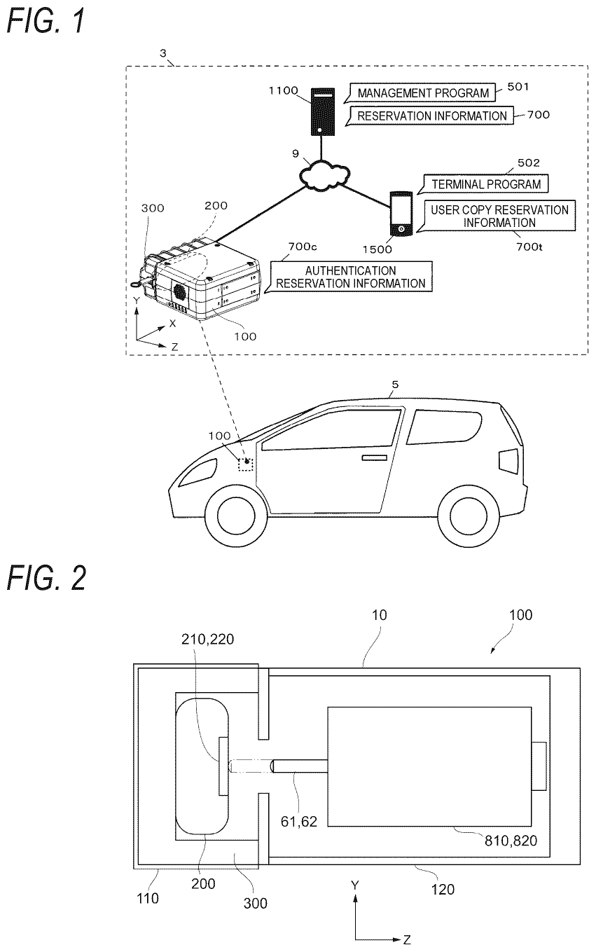

Hereinafter, a first embodiment according to the present invention will be described with reference to FIGS. 1 to 11. FIG. 1 is a schematic diagram showing a system configuration example of a sharing system 3 using an electronic key operation device 100 according to the present embodiment.

The sharing system 3 includes a vehicle 5 to be shared, an electronic key accommodation case 300 that accommodates a genuine electronic key 200 attached to the vehicle 5, an electronic key operation device 100 that is a vehicular device to which the electronic key accommodation case 300 is attached, a server system 1100 that performs communication connection with the electronic key operation device 100 via a network 9, and a user terminal 1500 that is used by a user to be shared and performs communication connection with the electronic key operation device 100 via the network 9. The vehicle 5 is mounted with at least one electronic key operation device 100. When the sharing system 3 is actually operated, one or a plurality of sets of the vehicle 5 and the electronic key operation device 100 are prepared, and one or a plurality of user terminals 1500 corresponding to the one or the plurality of prepared sets are used.

The electronic key 200 includes an unlocking button 210 and a locking button 220 (see FIG. 2) which are pressing buttons for unlocking/locking a locking mechanism provided in the vehicle 5 to be shared. The electronic key 200 transmits a predetermined unlocking signal when the unlocking button 210 is pressed, and transmits a predetermined locking signal when the locking button 220 is pressed. The network 9 means a communication path through which data communication is possible. A communication method may be wired or wireless. The electronic key accommodation case 300 is a member that accommodates the electronic key 200 therein, is attached to the electronic key operation device 100, and holds the electronic key 200 so that the unlocking button 210 or the locking button 220 can be pressed down by driving the electronic key operation device 100.

The server system 1100 performs user registration of the sharing system 3, reservation management, and provision of reservation information to the user terminal 1500 and the electronic key operation device 100. Specifically, by storing and executing a management program 501, the server system 1100 implements (1) a user registration function, (2) a reservation setting function for each vehicle 5, (3) a function of generating reservation information 700 (for example, including a unique reservation ID, a reserved vehicle ID, a reservation period, and a password), (4) a function of providing a copy of the reservation information 700 (reservation information 700t) to the user terminal 1500, and (5) a function of providing the copy of the reservation information 700 (reservation information 700c) to the electronic key operation device 100.

The user terminal 1500 is a computer system connectable to the network 9, which is used by the user, and is implemented by, for example, a smartphone, a tablet computer, a notebook computer, or a wearable computer.

The user terminal 1500 can store and execute an application program. As the application program, a terminal program 502 is stored. The terminal program 502 implements (1) a function of accessing the server system 1100, (2) a function of performing a predetermined unlocking request to the electronic key operation device 100 according to an unlocking operation by the user and providing the reservation information 700t to unlock the electronic key operation device 100, and (3) a function of performing communication connection with the electronic key operation device 100 according to a locking operation by the user to perform a predetermined locking request, and providing the reservation information 700t to lock the electronic key operation device 100.

An arrow indicating a first direction X, a second direction Y, or a third direction Z indicates that a direction from a base end to a tip end of the arrow is a positive direction of a direction indicated by the arrow, and a direction from the tip end to the base end of the arrow is a negative direction of the direction indicated by the arrow. The first direction X is parallel to an insertion and removal direction of the electronic key accommodation case 300 with respect to the electronic key operation device 100. A positive direction of the first direction X is an insertion direction of the electronic key accommodation case 300. A negative direction of the first direction X is a removal direction of the electronic key accommodation case 300. The second direction Y is orthogonal to the first direction X and parallel to a thickness direction of the electronic key operation device 100. A positive direction of the second direction Y is a direction from below to above the electronic key operation device 100. A negative direction of the second direction Y is a direction from above to below the electronic key operation device 100. The third direction Z is orthogonal to both the first direction X and the second direction Y. The third direction Z is parallel to a width direction of the electronic key operation device 100. A positive direction of the third direction Z is a direction from a side of the electronic key operation device 100 on which the electronic key accommodation case 300 is attached toward a side opposite to the attachment side. A negative direction of the third direction Z is a direction from the side of the electronic key operation device 100 opposite to the side on which the electronic key accommodation case 300 is attached toward the attachment side. The first direction X, the second direction Y, and the third direction Z in the drawings are also referred to as a depth direction, a thickness direction, and a width direction, respectively.

FIG. 2 is a schematic diagram conceptually showing an operation of the electronic key operation device 100 according to one embodiment. The electronic key operation device 100 includes a first actuator 810, a second actuator 820, a first pressing member 61, a second pressing member 62, an electronic key accommodation portion 110, and an operation mechanism portion 120. The electronic key 200 is accommodated in the electronic key accommodation case 300, and the electronic key accommodation case 300 is attached to the electronic key operation device 100 by an attachment portion (not shown). At this time, the electronic key 200 is positioned and held in the electronic key accommodation case 300 such that the unlocking button 210 and the locking button 220 face the electronic key operation device 100.

The electronic key accommodation portion 110 accommodates the electronic key 200. The electronic key accommodation portion 110 accommodates the electronic key 200 in a state in which the unlocking button 210 and the locking button 220 of the electronic key 200 are directed toward the first pressing member 61 and the second pressing member 62 in the operation mechanism portion 120. In the first embodiment, the electronic key 200 is accommodated in the electronic key accommodation portion 110 in a state of being stored in the electronic key accommodation case 300. In a state in which the electronic key accommodation case 300 is accommodated in the electronic key accommodation portion 110, the electronic key 200 is held at a position in which the unlocking button 210 and the first pressing member 61 face each other and the locking button 220 and the second pressing member 62 face each other.

The operation mechanism portion 120 is a mechanical structure portion for pressing the unlocking button 210 and the locking button 220 of the electronic key 200, and includes, in a housing portion 10, a controller (not shown), the first actuator 810 and the second actuator 820 that receive signals from the controller, the first pressing member 61 that receives power from the first actuator 810, and the second pressing member 62 that receives power from the second actuator 820.

The first actuator 810 is controlled by the controller (not shown) and serves as a driving unit that directly or indirectly applies power to the first pressing member 61. The first actuator 810 may be, for example, an electromagnetic solenoid, specifically, is implemented by a push-type linear solenoid, and can push out the rod-shaped first pressing member 61 by an electromagnetic force as a drive current is applied.

The second actuator 820 is controlled by the controller (not shown) and serves as a driving unit that directly or indirectly applies power to the second pressing member 62. The second actuator 820 has the same configuration as that of the first actuator 810. Accordingly, the second actuator 820 can push out the rod-shaped second pressing member 62 by an electromagnetic force as a drive current is applied. Although the first actuator 810 and the second actuator 820 have the same configuration in the present embodiment, the actuators may have different configurations.

When an instruction to unlock the electronic key 200 is given to the electronic key operation device 100 via the network 9, the first actuator 810 pushes out the first pressing member 61 according to a control instruction, and a tip end of the first pressing member 61 presses down the unlocking button 210 of the electronic key 200. Further, when an instruction to lock the electronic key 200 is given to the electronic key operation device 100 via the network 9, the second actuator 820 pushes out the second pressing member 62 according to a control instruction, and a tip end of the second pressing member 62 presses down the locking button 220 of the electronic key 200. Each of the pressing members (61, 62) can press the corresponding one of the buttons (the unlocking button 210, the locking button 220) of the electronic key 200, and can return to an original position by a return mechanism after the operation of the corresponding one of the actuators (810, 820) stops.

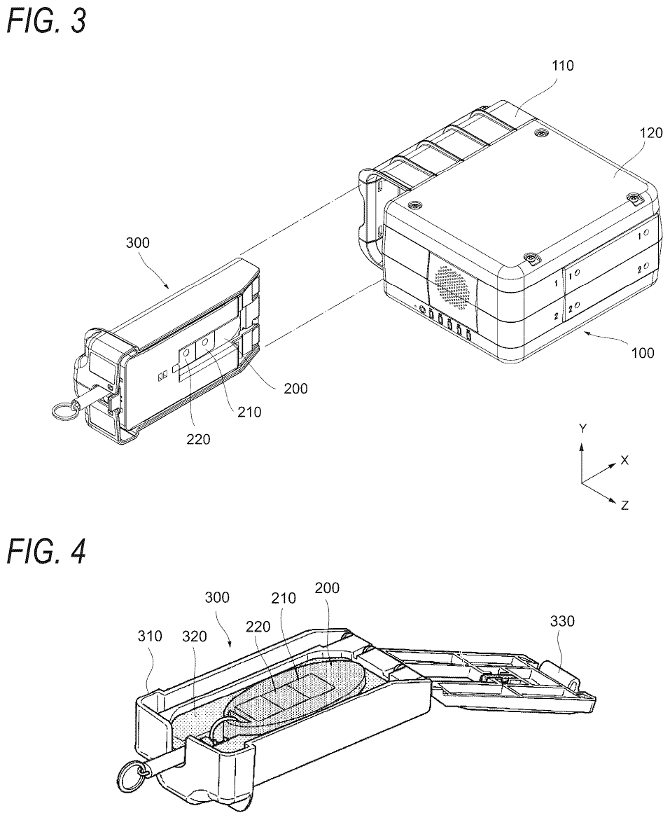

FIG. 3 is a schematic perspective view showing one embodiment in which the electronic key 200 accommodated in the electronic key accommodation case 300 is accommodated in the electronic key accommodation portion 110 of the electronic key operation device 100. FIG. 4 is a schematic perspective view schematically showing details of the electronic key accommodation case 300 used in the embodiment of FIG. 3 in a state in which the electronic key 200 is accommodated. As shown in FIGS. 3 and 4, the electronic key 200 is inserted into the electronic key accommodation portion 110 in the state of being stored in the electronic key accommodation case 300.

The electronic key accommodation case 300 includes a storage portion 310 for storing the electronic key 200, a key fitter 320, and a lid portion 330 for opening and closing an opening of the storage portion 310, and stores the electronic key 200 in a removable manner. When the electronic key accommodation case 300 stores the electronic key 200 in a state in which the unlocking button 210 and the locking button 220 of the electronic key 200 are exposed, and accordingly, the electronic key accommodation case 300 is accommodated in the electronic key accommodation portion 110, a pressing member 60 presses the unlocking button 210 and the locking button 220.

The key fitter 320 can have a shape corresponding to an outer shape of the electronic key 200. For example, the key fitter 320 may be a member formed of a hard sponge or the like in which an accommodation range of the electronic key 200 is hollowed out along the outer shape. The key fitter 320 positions the electronic key 200 so that the unlocking button 210 and the locking button 220 of the electronic key 200 are positioned at predetermined positions in the storage portion 310. The key fitter 320 is selected and used according to a type of the electronic key 200 of the vehicle to which the electronic key operation device 100 is attached.

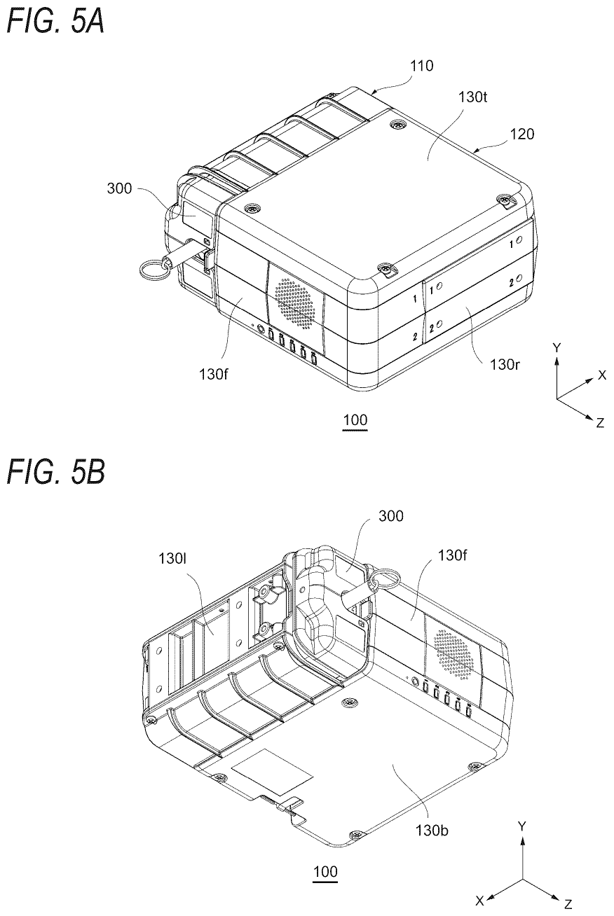

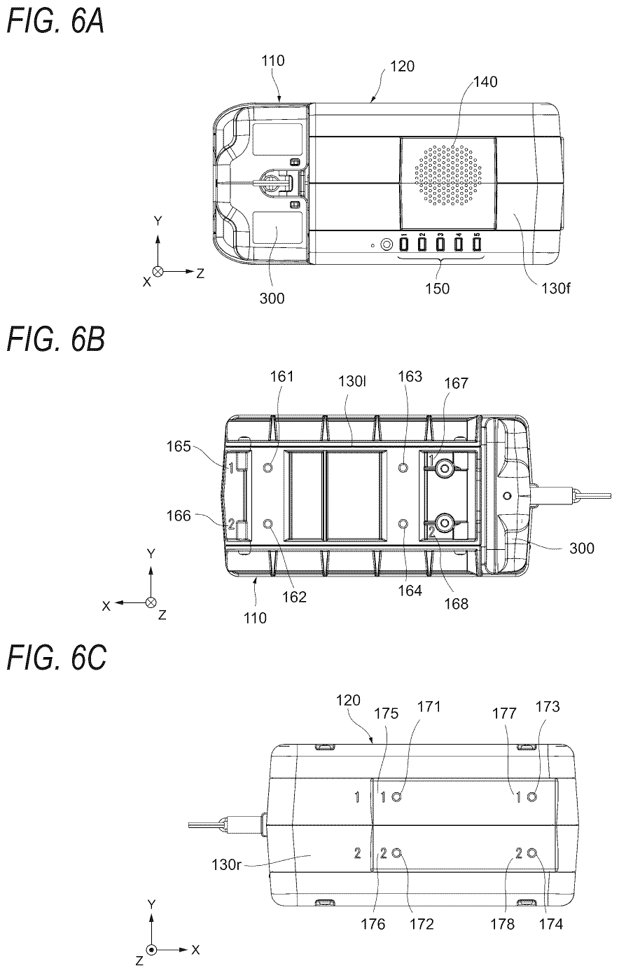

Next, each part of the electronic key operation device 100 will be described in detail with reference to FIGS. 5A and 5B and 6A to 6C. FIGS. 5A and 5B are schematic perspective views showing an overview of the electronic key operation device 100, FIG. 5A shows a front side, a top side, and a right side, and FIG. 5B shows the front side, a lower side, and a left side. FIGS. 6A to 6C are diagrams illustrating the overview of the electronic key operation device 100, FIG. 6A is a front view, FIG. 6B is a left-side view, and FIG. 6C is a right-side view.

As described above, the electronic key operation device 100 includes two portions, that is, the electronic key accommodation portion 110 and the operation mechanism portion 120, and is configured to have a box-shaped profile by combining the two portions. As an example, the box shape of the electronic key operation device 100 includes a front surface 130f, a rear surface (not shown), a top surface 130t, a bottom surface 130b, a right side surface 130r, and a left side surface 1301. Here, each of the front surface 130f, the rear surface, the top surface 130t, the bottom surface 130b, the right side surface 130r, and the left side surface 1301 does not mean a perfectly flat surface, but means the extent that each surface is recognizable as a surface as a whole while including irregularities or structures. In addition, the names of the respective surfaces are given for the sake of convenience, and actual vertical and lateral positions can be interchanged according to a direction in which the electronic key operation device 100 is arranged.

The front surface 130f is a surface directly facing the electronic key operation device 100 during an operation by the user, and forms a YZ plane at a negative direction end of an X axis in the example shown in FIGS. 5A and 5B and 6A to 6C. In the electronic key accommodation portion 110 on the front surface 130f, a part of the electronic key accommodation case 300 is exposed. The user can operate the electronic key accommodation case 300 from the front side to insert and remove the electronic key accommodation case 300 from the electronic key accommodation portion 110. Further, as shown in FIG. 6A, a speaker unit 140 and a display unit 150 are arranged in the operation mechanism portion 120 on the front surface 130f. The speaker unit 140 emits a sound under the control of the controller, and is used to notify the user of a guidance voice or an alarm. The display unit 150 displays an operation state of the electronic key operation device 100, and displays information for visually recognizing various kinds of information such as an ON/OFF state of a power supply, an attachment/detachment state of the electronic key accommodation case 300, and an accommodation state of the electronic key 200. A specific configuration of the display unit 150 is not limited, blinking of a plurality of light emitting diodes may be used, and an image display device may be used.

The left side surface 1301 is a surface located on the left side when the front surface 130f is viewed from the front side, and forms an XY plane at a negative direction end of a Z axis direction in the example shown in FIGS. 5A and 5B and 6A to 6C. Further, as shown in FIG. 6B, the left side surface 1301 constitutes a part of the electronic key accommodation portion 110, and is formed with fastening holes 161 to 164 and identification portions 165 to 168. The right side surface 130r is a surface located on the right side when the front surface 130f is viewed from the front side, and forms the XY plane at a positive direction end of the Z axis direction in the example shown in FIGS. 5A and 5B and 6A to 6C. Further, as shown in FIG. 6C, the right side surface 130r constitutes a part of the operation mechanism portion 120, and is formed with fastening holes 171 to 174 and identification portions 175 to 178.

The fastening holes 161 to 164 and 171 to 174 are portions for fixing a vehicular device attaching tool to be described later, and constitute fastening portions according to the present invention. Specific structures of the fastening holes 161 to 164 and 171 to 174 are not limited, and threaded holes, through holes, or the like can be used according to shape and structure of fasteners used for attaching the vehicular device attaching tool. The identification portions 165 to 168 and 175 to 178 are indicia formed in the vicinity of the fastening holes 161 to 164 and 171 to 174. Although in the example shown in FIGS. 5A and 5B and 6A to 6C, numerals are used as the identification portions 165 to 168 and 175 to 178, shapes and contents thereof are not limited, and English characters, figures, and the like may be used.

The number of and positions of the fastening holes 161 to 164 and 171 to 174 are not limited, and the fastening holes 161 to 164 and 171 to 174 are preferably formed at positions that are symmetrical in a vertical direction and a lateral direction of the electronic key operation device 100. Further, an outer shape of the electronic key operation device 100 is also preferably formed to be symmetrical in the vertical direction and the lateral direction. Specifically, in the example shown in FIGS. 5A and 5B and 6A to 6C, the fastening holes 161 to 164 on the left side surface 1301 and the corresponding fastening holes 171 to 174 on the right side surface 130r are formed at positions in which respective distances from the front surface 130f, the top surface 130t, and the bottom surface 130b are the same. Further, the distances from the top surface 130t to the fastening holes 161, 163, 171, and 173 are the same as the distances from the bottom surface 130b to the fastening holes 162, 164, 172, and 174. Accordingly, even when the vertical direction and the lateral direction of the electronic key operation device 100 are interchanged, the arrangement of the fastening holes 161 to 164 and 171 to 174 with respect to the vehicle is not changed before and after the interchanging, and the attachment can be performed by using the same vehicular device attaching tool.

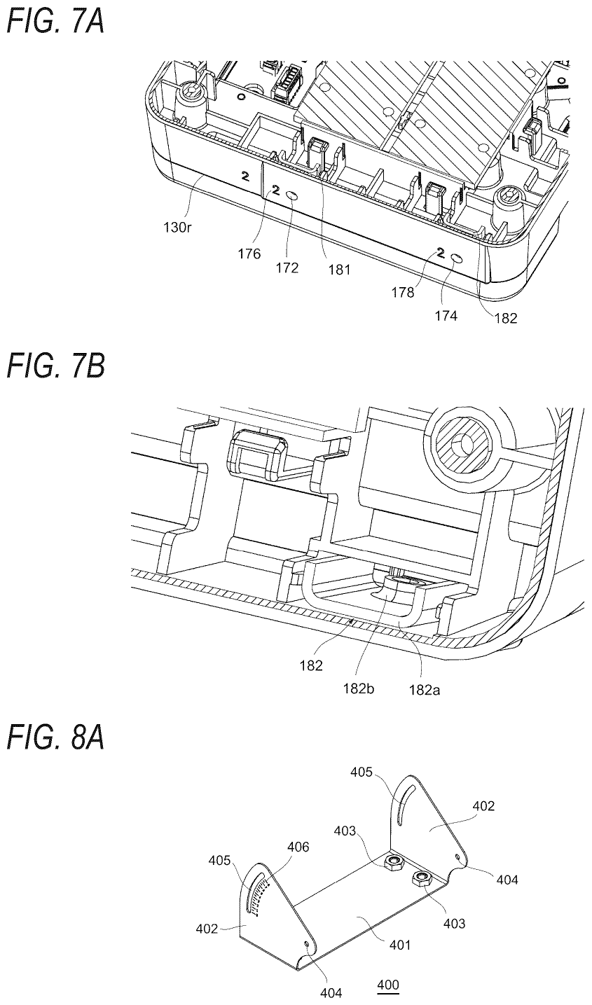

FIGS. 7A and 7B are perspective one-side cross-sectional views showing a structural example of the fastening portion, FIG. 7A is a perspective one-side cross-sectional view of the right side surface 130r, and FIG. 7B is a perspective one-side cross-sectional view in which a metal fixture 182 is enlarged. In the example shown in FIGS. 7A and 7B, the fastening holes 172 and 174 are through holes formed in the right side surface 130r and having a predetermined diameter. Further, metal fixtures 181 and 182 are arranged on an inner surface of the right side surface 130r at positions corresponding to the fastening holes 171 to 174. The metal fixture 182 has a plate-shaped portion 182a and a threaded hole portion 182b. The plate-shaped portion 182a is a substantially plate-shaped portion in contact with an inner surface of the right side surface 130r, and the threaded hole portion 182b is formed at a position corresponding to the fastening hole 174. The threaded hole portion 182b is a hole formed in the plate-shaped portion 182a, and is formed with a threaded groove corresponding to a fastener in an inner peripheral surface. In the example shown in FIGS. 7A and 7B, only the fastening holes 172 and 174 are shown and described, but the other fastening holes 161 to 164, 171, and 173 also have the same structure.

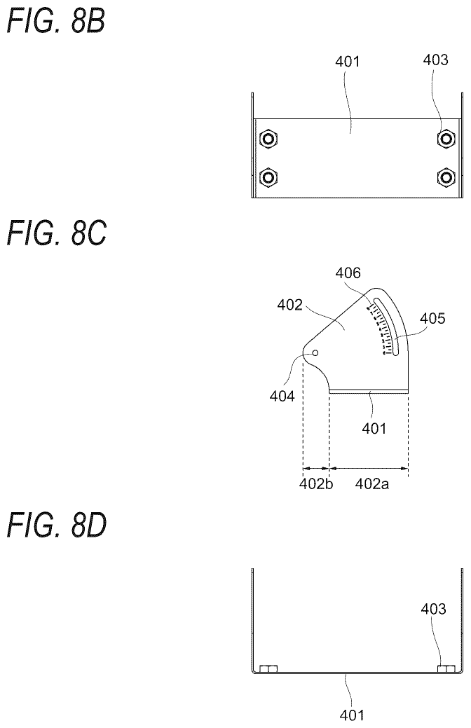

Next, a vehicular device attaching tool 400 for attaching the electronic key operation device 100 in the vehicle and a vehicular device attaching structure using the same will be described. FIGS. 8A, 8B, 8C, and 8D are schematic diagrams showing a structure of the vehicular device attaching tool 400, FIG. 8A is a schematic perspective view, FIG. 8B is a schematic top view, FIG. 8C is a schematic side view, and FIG. 8D is a schematic front view. As shown in FIGS. 8A, 8B, 8C, and 8D, the vehicular device attaching tool 400 includes a fixing portion 401, coupling portions 402, fixing holes 403, center holes 404, angle adjustment holes 405, and indicator portions 406.

The fixing portion 401 comes into contact with a mounting region in the vehicle for attaching the electronic key operation device 100. The shape of the fixing portion 401 is not limited, in the example shown in FIGS. 8A, 8B, 8C, and 8D, the fixing portion 401 has a substantially quadrilateral flat plate shape, and both end portions thereof are extended and erected to form the coupling portions 402. In addition, the fixing portion 401 has a shape corresponding to the mounting region on a vehicle side, the fixing portion 401 is not limited to the plate shape and may have irregularities or a curved surface as long as the fixing portion 401 can hold the electronic key operation device 100.

The coupling portions 402 extend from the fixing portion 401 and are coupled to the electronic key operation device 100. The shape of the coupling portions 402 is not limited, in the example shown in FIGS. 8A, 8B, 8C, and 8D, the coupling portions 402 have a substantially flat plate shape that is bent at a substantially right angle from the fixing portion 401 and is erected. Further, in the example shown in FIGS. 8A, 8B, 8C, and 8D, each coupling portion 402 includes a basic region 402a and an overhang region 402b. As shown in FIG. 8C, the basic region 402a is a region within a range in a width direction (a transverse direction in FIG. 8C) of the fixing portion 401 in a plan view. Further, as shown in FIG. 8C, the overhang region 402b is a region that deviates from the range in the width direction (the transverse direction in FIG. 8C) of the fixing portion 401 in the plan view.

The fixing holes 403 are holes through which fasteners (not shown) for fixing the vehicular device attaching tool 400 to the mounting region of the vehicle are inserted. In FIGS. 8A, 8B, 8C, and 8D, nut shapes formed integrally with the fixing portion 401 are shown as the fixing holes 403, and an example in which bolts are used as the fasteners is shown, but the specific shape, number, and arrangement are not limited. In addition, the fixing holes 403 may be omitted, and a back surface side of the fixing portion 401 and the mounting region of the vehicle may be adhered using a double-sided tape or an adhesive.

The center holes 404 are through holes formed in the coupling portions 402 and having a predetermined diameter, and are portions through which fasteners to be described later are inserted. In the example shown in FIGS. 8A, 8B, 8C, and 8D, the center holes 404 are formed in the overhang regions 402b of the coupling portions 402. The shape of the center holes 404 is not limited, and it is preferable that the shape is circular in order to allow the fasteners to rotate in a state in which the fasteners are inserted as described later.

The angle adjustment holes 405 are holes through which fasteners to be described later are inserted, and have a predetermined length. The angle adjustment holes 405 have a substantially constant width, and fastening positions of the fasteners can be changed to predetermined positions in a length direction. In the example shown in FIGS. 8A and 8C, the angle adjustment hole 405 is formed as a part of an arc centered at the center hole 404. At this time, a distance (a radius) from the center hole 404 to the angle adjustment hole 405 is set to be equal to any distance between the fastening holes 161 to 164 and 171 to 174 formed in the electronic key operation device 100. FIGS. 8A, 8B, 8C, and 8D show an example in which the angle adjustment hole 405 is set to have an arc shape with a central angle of about 40 degrees, but the length and the central angle of the arc are not limited.

The indicator portions 406 are indicia arranged along the length direction of the angle adjustment holes 405, and are used as indicators indicating the fastening positions. In the example shown in FIGS. 8A and 8C, a scale and a numerical value engraved on a surface of the coupling portion 402 are used as the indicator portion 406. The specific structure and display content of the indicator portion 406 are not limited, printing or seal attachment may be used, and angles around the center hole 404 may be indicated.

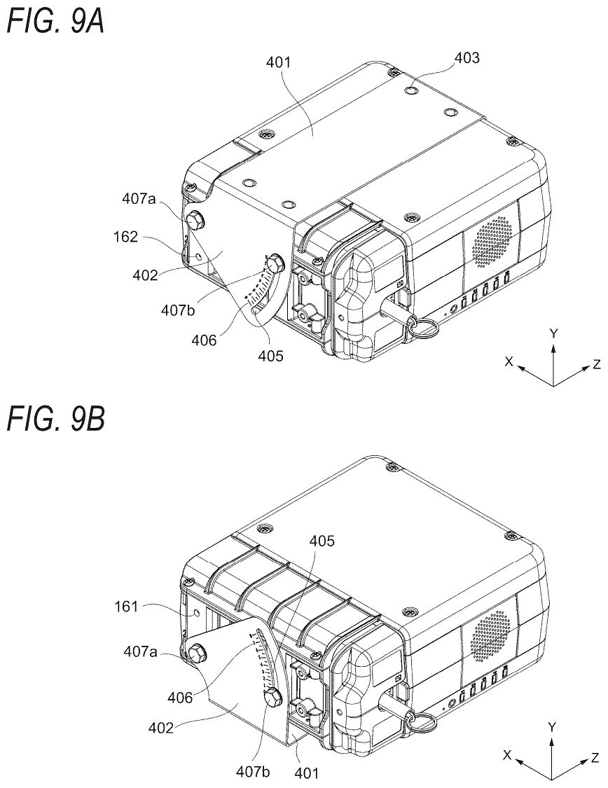

FIGS. 9A and 9B are schematic perspective views showing a state in which the vehicular device attaching tool 400 is attached to the electronic key operation device 100, FIG. 9A shows a case in which the vehicular device attaching tool 400 is attached on a top surface 130t side, and FIG. 9B shows a case in which the vehicular device attaching tool 400 is attached on a bottom surface 130b side. As shown in FIGS. 9A and 9B, the vehicular device attaching structure according to the present embodiment has a structure in which fasteners 407a are inserted into the center holes 404, fasteners 407b are inserted into the angle adjustment holes 405, and the coupling portions 402 are coupled to the electronic key operation device 100.

The fasteners 407a and 407b have a diameter and a shape corresponding to the fastening holes 161 to 164 and 171 to 174, and are inserted into and fastened to selected fastening holes among the fastening holes 161 to 164 and 171 to 174. Specific configurations of the fasteners 407a and 407b are not limited, and for example, threads, bolts, rivets, or the like can be used.

In the example shown in FIG. 9A, the fixing portion 401 is arranged on the top surface 130t side, the center hole 404 is aligned with the fastening hole 161 and is fastened by the fastener 407a, and the angle adjustment hole 405 is overlapped with the fastening hole 163 and is fastened by the fastener 407b. Therefore, the distance between the center hole 404 and the angle adjustment hole 405 is equal to a distance between the fastening holes 161 and 163. In the example shown in FIG. 9B, the fixing portion 401 is arranged on the bottom surface 130b side, the center hole 404 is aligned with the fastening hole 162 and is fastened by the fastener 407a, and the angle adjustment hole 405 is overlapped with the fastening hole 164 and is fastened by the fastener 407b. Therefore, the distance between the center hole 404 and the angle adjustment hole 405 is equal to a distance between the fastening holes 162 and 164.

As shown in FIGS. 9A and 9B, the outer shape of the electronic key operation device 100 is vertically and laterally symmetric, and the arrangement of the fastening holes 161 to 164 and 171 to 174 is also vertically and laterally symmetric, and thus a coupling direction of the electronic key operation device 100 and the vehicular device attaching tool 400 can be interchanged in the vertical direction and the lateral direction. In addition, when the vehicular device attaching structure shown in FIGS. 9A and 9B is fixed to the mounting region of the vehicle, the electronic key operation device 100 may be vertically inverted and arranged, and the electronic key operation device 100 may be arranged vertically with the right side surface 130r or the left side surface 1301 facing downward.

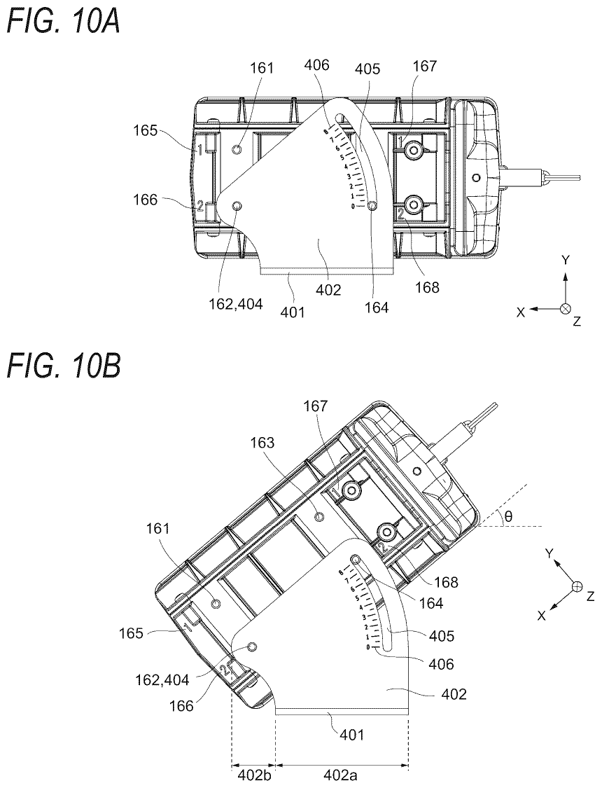

FIGS. 10A and 10B are schematic side views showing angle adjustment of the vehicular device attaching tool 400 with respect to the electronic key operation device 100, FIG. 10A shows a case in which the electronic key operation device 100 is held parallel to the fixing portion 401, and FIG. 10B shows a case in which an electronic key operation device 100 is held by being tilted at an angle θ with respect to the fixing portion 401. In FIGS. 10A and 10B, the fasteners 407a and 407b are not shown in order to show a positional relation of the center hole 404, the angle adjustment hole 405, and the fastening holes 161 to 164. Further, the left side surface 1301 is described with reference to FIGS. 10A and 10B, and the same applies to the right side surface 130r. Further, an example in which the vehicular device attaching tool 400 is arranged on the bottom surface 130b side is described, and the same applies to a case in which the vehicular device attaching tool 400 is arranged on the top surface 130t side.

When the vehicular device attaching tool 400 is coupled to the electronic key operation device 100, a worker as a sharing operator or a vehicle maintenance operator checks an attachment instruction sheet predetermined for each vehicle type. The attachment instruction sheet shows the type of the vehicular device attaching tool 400 used according to the vehicle type, the used fastening holes 161 to 164 and 171 to 174, and the fastening positions at the angle adjustment holes 405.

The example shown in FIG. 10A refers to a case in which the fastening portions are described by “2”, positions are described by an angle “0”, and the center holes 404 are described as “rear” in the attachment instruction sheet. In this case, the worker searches identification portions from the identification portions 165 to 168 and 175 to 178, which correspond to “2”, among the fastening holes 161 to 164 and 171 to 174. Among the identification portions 165 to 168 and 175 to 178, the identification portions 166, 168, 176, and 178 are shown by “2”, and the fastening holes 162 and 174 are positioned in the vicinity of the rear thereof (a positive direction side in the X direction), and thus the worker aligns the center holes 404 with the fastening holes 162 and 174. In this state, it is preferable to insert the fasteners 407a into the center holes 404 and the fastening holes 162 and 174 to perform temporary fastening.

As described above, since the distance between the center hole 404 and the angle adjustment hole 405 is equal to the distance between the fastening holes 162 and 164, the fastening holes 164 and 172 can be positioned in the angle adjustment holes 405 in a state in which the center holes 404 and the fastening holes 162 and 174 are temporarily fastened by using the fasteners 407a. Further, since the vehicular device attaching tool 400 is rotatable with the center holes 404 as rotation centers, the worker searches positions corresponding to the angle “0” in the indicator portions 406, aligns the fastening holes 164 and 172 with the positions at the angle “0”, and fastens the fastening holes 164 and 172 by the fasteners 407b. Thereafter, by firmly fastening the fasteners 407a and 407b, it is possible to obtain the vehicular device attaching structure in which the vehicular device attaching tool 400 is coupled to the electronic key operation device 100 at the positions and the angle designated by the attachment instruction sheet. After an operation of coupling the vehicular device attaching tool 400 to the electronic key operation device 100, the worker fixes the fixing portion 401 of the vehicular device attaching tool 400 to the mounting region of the vehicle and mounts the vehicular device attaching structure on the vehicle.

Similarly, the example shown in FIG. 10B refers to a case in which the fastening portions are described by “2”, positions are described by an angle “8”, and the center holes 404 are described as “rear” in the attachment instruction sheet. Also in this case, the worker performs selection of the fastening holes 161 to 164 and 171 to 174, temporary fastening of the center holes 404, position selection in the indicator portions 406, and fastening of the angle adjustment holes 405. Accordingly, it is possible to obtain a vehicular device attaching structure in which the vehicular device attaching tool 400 is tilted at a predetermined angle 0 with respect to the fixing portion 401.

As described above, since the distance between the center hole 404 and the angle adjustment hole 405 is equal to the distance between the fastening holes 162 and 164, the coupling portion 402 necessarily needs to be formed larger than the distance. However, the coupling portion 402 includes the basic region 402a and the overhang region 402b, and the center hole 404 is formed in the overhang region 402b, and thus a width (a transverse direction in FIGS. 10A and 10B) of the basic region 402a can be reduced. In other words, since the width of the basic region 402a is a width of the fixing portion 401, a contact area with the vehicle can be reduced by reducing the width of the fixing portion 401. The vehicular device attaching tool 400 and the vehicular device attaching structure are often mounted in a region that can be hidden from a vehicle interior such as a glovebox or a luggage space of the vehicle. Therefore, it is difficult to secure the mounting region for attaching the fixing portion 401, and the degree of freedom in selection of the mounting region can be improved by providing the center holes 404 in the overhang regions 402b to reduce the width of the fixing portion 401.

Further, a distance between the center hole 404 and the fixing portion 401 is preferably larger than a distance from corners on the bottom surface 130b and the rear surface of the electronic key operation device 100 to the fastening holes 162 and 174. Accordingly, as shown in FIG. 10B, even when the electronic key operation device 100 is maximally tilted with respect to the fixing portion 401, it is possible to prevent the corner portions of the electronic key operation device 100 from interfering with the fixing portion 401, and to improve the degree of freedom of an attachment angle of the electronic key operation device 100. In addition, although an example is shown in FIGS. 10A and 10B in which a lower end and an upper end of the angle adjustment hole 405 are set to the fastening position of the fastening hole 164, the electronic key operation device 100 can be attached to the vehicle at any angle by using the fastener 407b to fasten the fastening hole 164 at any position in the angle adjustment hole 405.

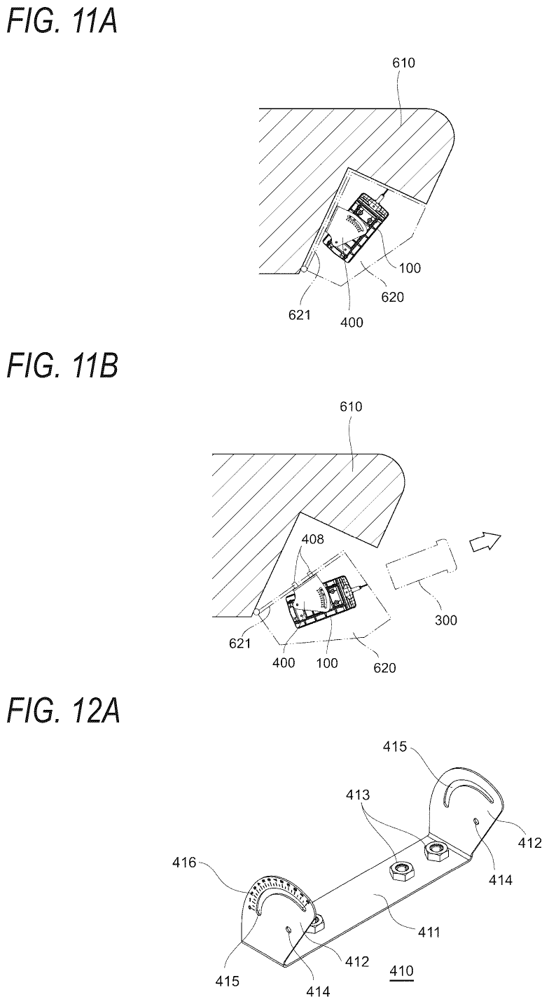

FIGS. 11A and 11B are diagrams illustrating an insertion and removal operation of the electronic key accommodation case 300 when the electronic key operation device 100 is mounted on the vehicle by using the vehicular device attaching tool 400, FIG. 11A shows a state in which a glovebox 620 is closed, and FIG. 11B shows a state in which the glovebox 620 is opened. In the example shown in FIGS. 11A and 11B, the inside of the glovebox 620 arranged in an instrument panel 610 of the vehicle is set as the mounting region of the electronic key operation device 100. Further, the vehicular device attaching tool 400 is fixed to a wall surface 621 of the glovebox 620 on a depth side. The worker temporarily removes the glovebox 620 from the instrument panel 610, and attaches the vehicular device attaching structure to the wall surface 621 outside the vehicle by using fasteners 408 such as bolts. Thereafter, the glovebox 620 is returned to the instrument panel 610, various wirings are installed, and this attachment operation is completed. Since the wall surface 621 is located on the depth side of the glovebox 620, and is hidden inside the instrument panel 610 when the vehicle is used, the fasteners 408 are not visually recognized by the user and the appearance can be improved.

As shown in FIG. 11B, by appropriately setting the fastening positions in the angle adjustment holes 405 using the vehicular device attaching tool 400 according to the present embodiment, the tilt of the electronic key operation device 100 in the state in which the glovebox 620 is opened can be appropriately maintained even when a shape of the glovebox 620 is different for each vehicle type. Here, the appropriate tilt of the electronic key operation device 100 means that the insertion and removal operation of the electronic key accommodation case 300 is not hindered by the instrument panel 610 or the glovebox 620. Therefore, the user can open the glovebox 620 to easily perform the insertion and removal operation of the electronic key accommodation case 300.

Next, an example of a usage procedure of a sharing service according to the present embodiment will be described. First, the user makes a predetermined unlocking request to the electronic key operation device 100 via the network 9 by using the user terminal 1500 in the vicinity of the vehicle. After receiving the unlocking request, the electronic key operation device 100 drives the first pressing member 61 by the first actuator 810 to press down the unlocking button 210 and unlock a door of the vehicle. When the user opens the door and gets on the vehicle, the electronic key operation device 100 causes the speaker unit 140 to notify a guidance voice such as “please open the glovebox” when the controller (not shown) detects the getting on of the user, for example.

When the user opens the glovebox 620 from the state shown in FIG. 11A according to the guidance voice, the user can access the electronic key operation device 100 fixed by the vehicular device attaching tool 400 from the vehicle interior as shown in FIG. 11B. At a timing when the glovebox 620 is opened (for example, at a timing when the controller detects that the glovebox 620 is in an open state), the electronic key operation device 100 causes the speaker unit 140 to notify a guidance voice such as “please take out a key case and take out a key”. According to the guidance voice, the user removes the electronic key accommodation case 300 from the electronic key operation device 100, and takes out the electronic key 200 from the electronic key accommodation case 300. At a timing when the electronic key 200 is taken out (for example, at a timing when the controller detects removal of the electronic key 200 by a detection sensor or the like), the electronic key operation device 100 causes the speaker unit 140 to notify a guidance voice such as “please return the key case to an original state and close the glovebox”. According to the guidance voice, the user inserts the empty electronic key accommodation case 300 into the electronic key operation device 100, closes the glovebox 620 to be in the state of FIG. 11A, and drives the vehicle by using the taken-out electronic key 200.

In a case in which the user stops driving the vehicle, for example, in a case in which the controller (not shown) recognizes that a current position of the vehicle reaches a return location of the vehicle, the electronic key operation device 100 causes the speaker unit 140 to notify a guidance voice such as “please open the glovebox, take out the key case, and accommodate the key”. According to the guidance voice, the user opens the glovebox 620 again, removes the electronic key accommodation case 300, and accommodates the electronic key 200 in the electronic key accommodation case 300 at a predetermined position and orientation. At a timing when the user accommodates the electronic key 200 in the electronic key accommodation case 300 (for example, at a timing when the controller detects attachment of the electronic key 200 by a detection sensor or the like), the electronic key operation device 100 causes the speaker unit 140 to notify the guidance voice such as “please return the key case to the original state and close the glovebox”. According to the guidance voice, the user inserts the electronic key accommodation case 300 into the electronic key operation device 100, closes the glovebox 620 to be in the state of FIG. 11A again, and exits the vehicle.

Finally, the user makes a predetermined locking request to the electronic key operation device 100 via the network 9 by using the user terminal 1500 in the vicinity of the vehicle. After receiving the locking request, the electronic key operation device 100 drives the second pressing member 62 by the second actuator 820 to press down the locking button 220 and lock the door of the vehicle. The electronic key operation device 100 transmits the end of usage of the sharing service by the user to the server system 1100 via the network 9.

As described above, by using the vehicular device attaching tool 400 and the vehicular device attaching structure according to the present embodiment in which the center holes 404 and the angle adjustment holes 405 are formed, the electronic key operation device 100 which is a vehicular device can be fixed to the mounting region of the vehicle at an appropriate angle. In addition, since the angle adjustment hole 405 is formed in the arc shape centered at the center hole 404, it is possible to hold the electronic key operation device 100 at various angles according to the vehicle type so that the user of the sharing system 3 can easily insert and remove the electronic key accommodation case 300.

### Second Embodiment

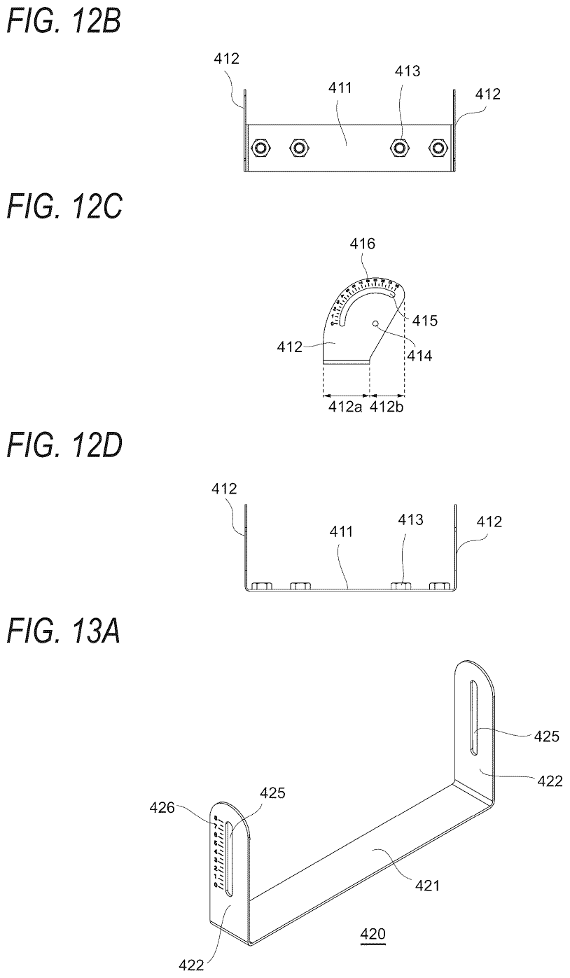

Next, a second embodiment according to the present invention will be described with reference to FIGS. 12 to 16. Description of contents overlapping with the first embodiment will be omitted. The present embodiment is different from the first embodiment in that a vehicular device attaching tool 420 having an additional coupling portion is used in addition to a vehicular device attaching tool 410. FIGS. 12A, 12B, 12C, and 12D are schematic diagrams showing a structure of the vehicular device attaching tool 410, FIG. 12A is a schematic perspective view, FIG. 12B is a schematic top view, FIG. 12C is a schematic side view, and FIG. 12D is a schematic front view. As shown in FIGS. 12A, 12B, 12C, and 12D, the vehicular device attaching tool 410 includes a fixing portion 411, coupling portions 412, fixing holes 413, center holes 414, angle adjustment holes 415, and indicator portions 416.

The fixing portion 411 comes into contact with the mounting region in the vehicle for attaching the electronic key operation device 100. The coupling portions 412 extend from the fixing portion 411 and are coupled to the electronic key operation device 100. The fixing holes 413 are holes through which fasteners (not shown) for fixing the vehicular device attaching tool 410 to the mounting region of the vehicle are inserted. The center holes 414 are through holes formed in the coupling portions 412 and having a predetermined diameter, and are portions through which fasteners are inserted. The angle adjustment holes 415 are holes through which fasteners are inserted, and have a predetermined length. The indicator portions 416 are indicia arranged along a length direction of the angle adjustment holes 415, and are used as indicators indicating fastening positions.

Further, in the example shown in FIGS. 12A, 12B, 12C, and 12D, each coupling portion 412 includes a basic region 412a and an overhang region 412b. As shown in FIG. 12C, the basic region 412a is a region within a range in a width direction (a transverse direction in FIG. 12C) of the fixing portion 411 in a plan view. Further, as shown in FIG. 12C, the overhang region 412b is a region that deviates from the range in the width direction (the transverse direction in FIG. 12C) of the fixing portion 411 in the plan view. In addition, the angle adjustment hole 415 is formed as a part of an arc centered at the center hole 414. At this time, a distance (a radius) from the center hole 414 to the angle adjustment hole 415 is set to be equal to a distance between the fastening holes 161 and 162 formed in the electronic key operation device 100. FIGS. 12A, 12B, 12C, and 12D show an example in which the angle adjustment hole 415 is set to have an arc shape with a central angle of about 120 degrees, but the length and the central angle of the arc are not limited.

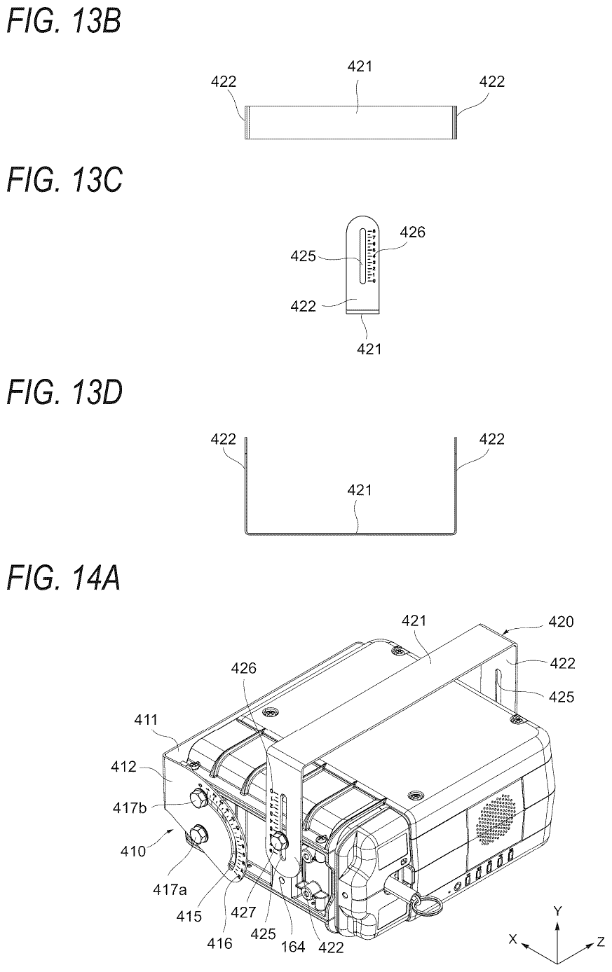

FIGS. 13A, 13B, 13C, and 13D are schematic diagrams showing a structure of the vehicular device attaching tool 420, FIG. 13A is a schematic perspective view, FIG. 13B is a schematic top view, FIG. 13C is a schematic side view, and FIG. 13D is a schematic front view. As shown in FIGS. 13A, 13B, 13C, and 13D, the vehicular device attaching tool 420 includes a fixing portion 421, coupling portions 422, angle adjustment holes 425, and indicator portions 426.

The fixing portion 421 comes into contact with the mounting region in the vehicle for attaching the electronic key operation device 100. The shape of the fixing portion 421 is not limited, in the example shown in FIGS. 13A, 13B, 13C, and 13D, the fixing portion 421 has a substantially quadrilateral flat plate shape, and both end portions thereof are extended and erected to form the coupling portions 422. In the present embodiment, a back surface side of the fixing portion 421 is attached to the vehicle side by using an adhesive or an adhesive member (not shown) such as a double-sided tape.

The coupling portions 422 extend from the fixing portion 421 and are coupled to the electronic key operation device 100, and correspond to the additional coupling portion in the present invention. The shape of the coupling portions 422 is not limited, in the example shown in FIGS. 13A, 13B, 13C, and 13D, the coupling portions 422 have a substantially flat plate shape that is bent at a substantially right angle from the fixing portion 421 and is erected.

The angle adjustment holes 425 are holes through which fasteners to be described later are inserted, have a predetermined length, and correspond to an additional adjustment hole in the present invention. The angle adjustment holes 425 have a substantially constant width, and fastening positions of the fasteners can be changed to predetermined positions in a length direction. In the example shown in FIGS. 13A, 13B, 13C, and 13D, the angle adjustment holes 425 are formed in a substantially linear shape. The indicator portions 426 are indicia arranged along the length direction of the angle adjustment holes 425, and are used as indicators indicating the fastening positions.

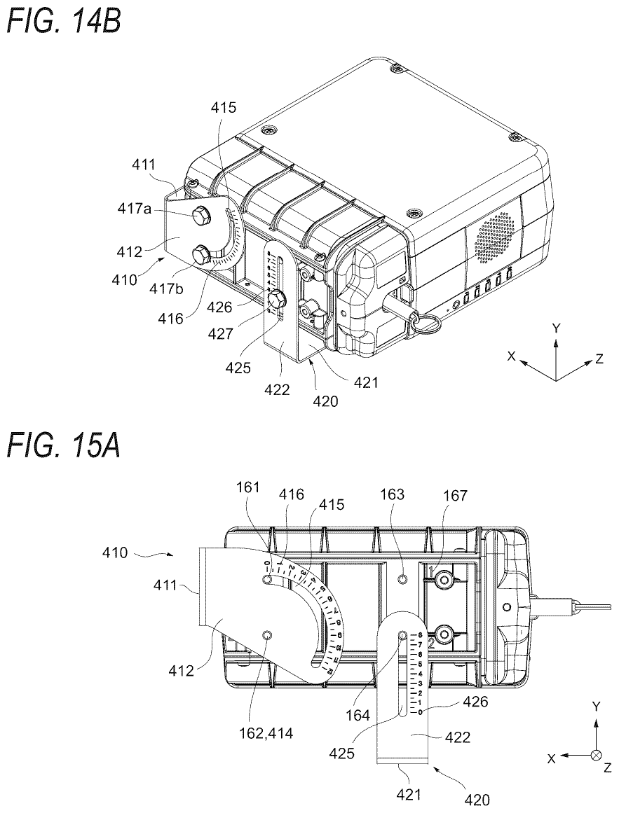

FIGS. 14A and 14B are schematic perspective views showing a state in which the vehicular device attaching tools 410 and 420 are attached to the electronic key operation device 100, FIG. 14A shows a case in which the vehicular device attaching tool 420 is attached on the top surface 130t side, and FIG. 14B shows a case in which the vehicular device attaching tool 420 is attached on the bottom surface 130b side. As shown in FIGS. 14A and 14B, in the vehicular device attaching structure according to the present embodiment, fasteners 417a are inserted into the center holes 414 of the vehicular device attaching tool 410, fasteners 417b are inserted into the angle adjustment holes 415, and the coupling portions 412 are coupled to the electronic key operation device 100. Further, in the vehicular device attaching structure, fasteners 427 are inserted into the angle adjustment holes 425 of the vehicular device attaching tool 420, and the coupling portions 422 are coupled to the electronic key operation device 100.

In the example shown in FIG. 14A, the fixing portion 421 is arranged on the top surface 130t side, the center hole 414 is aligned with the fastening hole 162 and is fastened by the fasteners 417a, and the angle adjustment hole 415 is overlapped with the fastening hole 161 and is fastened by the fastener 417b. Therefore, the distance between the center hole 414 and the angle adjustment hole 415 is equal to the distance between the fastening holes 161 and 162. In the example shown in FIG. 14B, the fixing portion 421 is arranged on the bottom surface 130b side, the center hole 414 is aligned with the fastening hole 161 and is fastened by the fastener 417a, and the angle adjustment hole 415 is overlapped with the fastening hole 162 and is fastened by the fastener 417b.

As shown in FIGS. 14A and 14B, the outer shape of the electronic key operation device 100 is vertically and laterally symmetric, and the arrangement of the fastening holes 161 to 164 and 171 to 174 is also vertically and laterally symmetric, and thus coupling directions of the electronic key operation device 100 and the vehicular device attaching tools 410 and 420 can be interchanged in the vertical direction and the lateral direction. In addition, when the vehicular device attaching structure shown in FIGS. 14A and 14B is fixed to the mounting region of the vehicle, the electronic key operation device 100 may be vertically inverted and arranged, and the electronic key operation device 100 may be arranged vertically with the right side surface 130r or the left side surface 1301 facing downward.

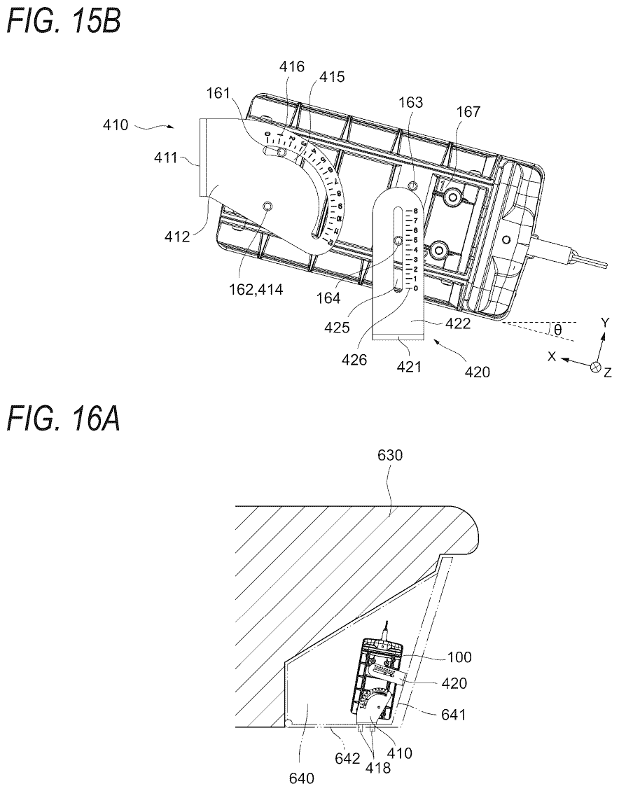

FIGS. 15A and 15B are schematic side views showing angle adjustment of the vehicular device attaching tools 410 and 420 with respect to the electronic key operation device 100, FIG. 15A shows a case in which the electronic key operation device 100 is held parallel to the fixing portion 421, and FIG. 15B shows a case in which the electronic key operation device 100 is held by being tilted at the angle 0 with respect to the fixing portion 421. In FIGS. 15A and 15B, the fasteners 417a, 417b, and 427 are not shown in order to show a positional relation of the center hole 414, the angle adjustment holes 415 and 425, and the fastening holes 161 to 164.

The example shown in FIG. 15A refers to a case in which the fastening portions are described by “2”, positions are described by an angle “0” and a height “8”, and the center holes 414 are described as “rear” in the attachment instruction sheet. In this case, the worker aligns the center holes 414 with the fastening holes 162 and 174. As described above, since the distance between the center hole 414 and the angle adjustment hole 415 is equal to the distance between the fastening holes 161 and 162, the fastening holes 161 and 173 can be positioned in the angle adjustment holes 415 in a state in which the center holes 414 and the fastening holes 162 and 174 are temporarily fastened by using the fasteners 417a. Further, since the vehicular device attaching tool 400 is rotatable with the center holes 414 as rotation centers, the worker searches positions corresponding to the angle “0” in the indicator portions 416, aligns the fastening holes 161 and 173 with the positions at the angle “0”, and fastens the fastening holes 161 and 173 by the fasteners 417b. Thereafter, the fasteners 417a and 417b are firmly fastened. In addition, the worker searches positions corresponding to the height “8” of the angle adjustment holes 425 in the indicator portion 426, aligns the fastening holes 164 and 172 with the positions at the height “8”, and fastens the fastening holes 164 and 172 by the fasteners 427.

According to the above procedure, the worker can obtain the vehicular device attaching structure in which the vehicular device attaching tools 410 and 420 are coupled to the electronic key operation device 100 at the positions and the angle designated by the attachment instruction sheet. Further, after an operation of coupling the vehicular device attaching tools 410 and 420 to the electronic key operation device 100, the worker fixes the fixing portions 411 and 421 of the vehicular device attaching tools 410 and 420 to the mounting region of the vehicle and mounts the vehicular device attaching structure on the vehicle.

Similarly, the example shown in FIG. 15B refers to a case in which the fastening portions are described by “2”, positions are described by an angle “1.5” and a height “5”, and the center holes 414 are described as “rear” in the attachment instruction sheet. Also in this case, the worker performs the selection of the fastening holes 161 to 164 and 171 to 174, temporary fastening of the center holes 414, position selection in the indicator portions 416 and 426, and fastening of the angle adjustment holes 415 and 425. Accordingly, it is possible to obtain a vehicular device attaching structure in which the vehicular device attaching tool 400 is tilted at a predetermined angle θ with respect to the fixing portion 411.

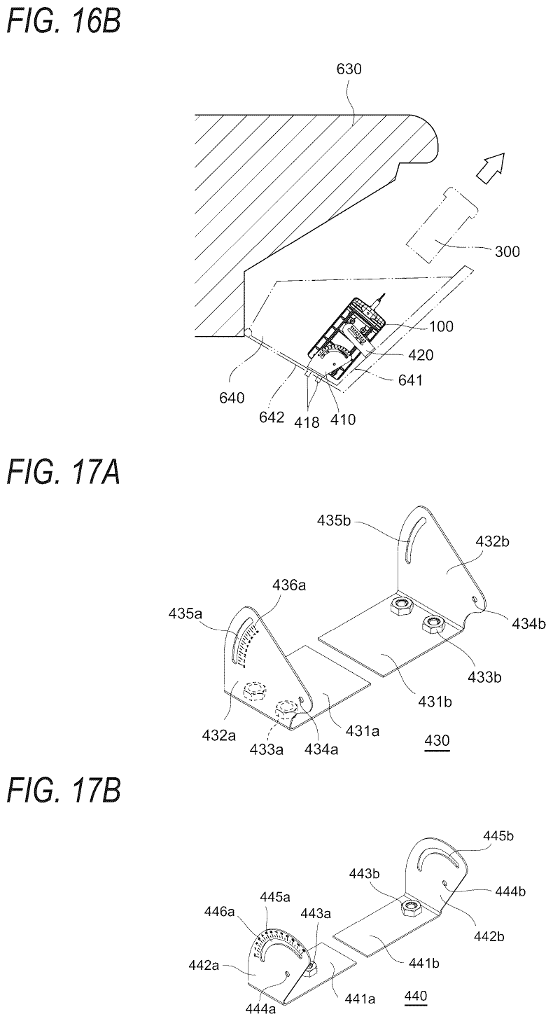

FIGS. 16A and 16B are diagrams illustrating the insertion and removal operation of the electronic key accommodation case 300 when the electronic key operation device 100 is mounted on the vehicle by using the vehicular device attaching tools 410 and 420, FIG. 16A shows a state in which the glovebox 620 is closed, and FIG. 16B shows a state in which the glovebox 620 is opened. In the example shown in FIGS. 16A and 16B, the inside of a glovebox 640 arranged in an instrument panel 630 of the vehicle is set as the mounting region of the electronic key operation device 100. In addition, the vehicular device attaching tool 420 is attached to a wall surface 641 of the glovebox 640 on a vehicle interior side with a double-sided tape (not shown). Further, the vehicular device attaching tool 410 is fixed to a bottom surface 642 of the glovebox 640 by using fasteners 418 such as bolts. Since the bottom surface 642 is located at the bottom of the glovebox 640, and is hidden from the vehicle interior when the vehicle is used, the fasteners 418 are not visually recognized by the user and the appearance can be improved.

Also in the present embodiment, by using the vehicular device attaching tool 410 and the vehicular device attaching structure in which the center holes 404 and the angle adjustment holes 405 are formed, the electronic key operation device 100 which is a vehicular device can be fixed to the mounting region of the vehicle at an appropriate angle. In addition, since the angle adjustment hole 415 is formed in the arc shape centered at the center hole 414, it is possible to hold the electronic key operation device 100 at various angles according to the vehicle type so that the user of the sharing system 3 can easily insert and remove the electronic key accommodation case 300. Further, the coupling portion 412 includes the basic region 412a and the overhang region 412b, and the center hole 414 is formed in the overhang region 412b, and thus a width (a transverse direction in FIGS. 16A and 16B) of the basic region 412a can be reduced.

In addition, since the vehicular device attaching tools 410 and 420 are used in combination, and the coupling portions 412 and 422 are coupled to different positions among the fastening holes 161 to 164 and 171 to 174, the electronic key operation device 100 can be firmly held at a plurality of locations. Further, by separating the fixing portions 411 and 421 of the vehicular device attaching tools 410 and 420, the electronic key operation device 100 can be fixed in contact with a plurality of surfaces of the vehicle, and the degree of freedom in design can be improved while securing the strength of fixation.

### Third Embodiment

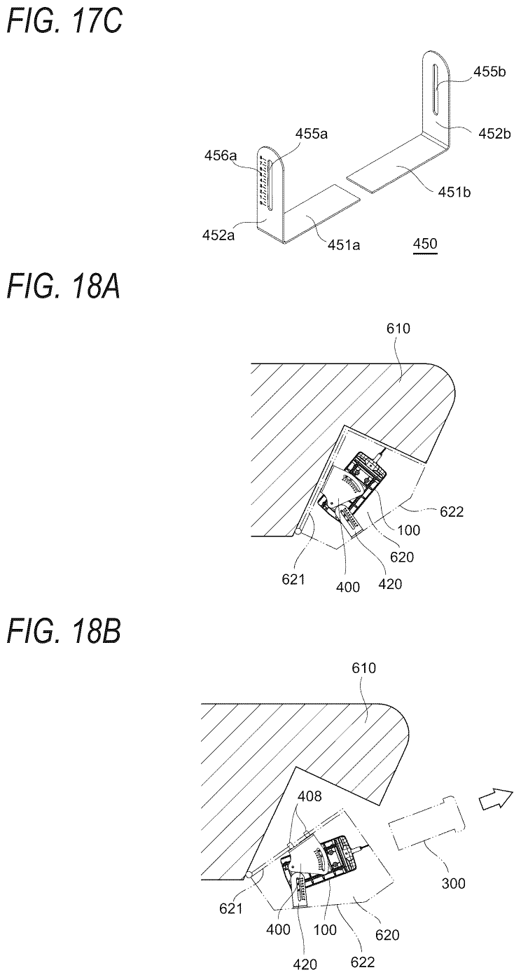

Next, a third embodiment according to the present invention will be described with reference to FIGS. 17A to 17C. Description of contents overlapping with the first embodiment will be omitted. The present embodiment is different from the first embodiment and the second embodiment in that the vehicular device attaching tool is divided into left and right portions. FIGS. 17A to 17C are schematic perspective views showing structures of vehicular device attaching tools 430 to 450.

As shown in FIG. 17A, the vehicular device attaching tool 430 is divided into left and right portions, and includes fixing portions 431a and 431b, coupling portions 432a and 432b, fixing holes 433a and 433b, center holes 434a and 434b, angle adjustment holes 435a and 435b, and indicator portions 436a and 436b. Similarly, as shown in FIG. 17B, the vehicular device attaching tool 440 is divided into left and right portions, and includes fixing portions 441a and 441b, coupling portions 442a and 442b, fixing holes 443a and 443b, center holes 444a and 444b, angle adjustment holes 445a and 445b, and indicator portions 446a and 446b. In addition, as shown in FIG. 17C, the vehicular device attaching tool 450 is divided into left and right portions, and includes fixing portions 451a and 451b, coupling portions 452a and 452b, angle adjustment holes 455a and 455b, and indicator portions 456a and 456b.

In the present embodiment, by using the vehicular device attaching tools 430 to 450 each of which is divided into the left and right portions, it is possible to reduce areas of the fixing portions 431a, 431b, 441a, 441b, 451a, and 451b and further reduce contact areas in the mounting region of the vehicle. Further, it is possible to individually set angles of the left side surface 130l and the right side surface 130r of the electronic key operation device 100, and it is possible to improve the degree of freedom in installation of the vehicular device attaching tools 430 to 450.

### Fourth Embodiment

Next, a fourth embodiment according to the present invention will be described with reference to FIGS. 18A and 18B. Description of contents overlapping with the first embodiment will be omitted. The present embodiment is different from the first embodiment and the second embodiment in that the vehicular device attaching tools 400 and 420 are respectively fixed to different surfaces in the glovebox 620. FIGS. 18A and 18B are diagrams illustrating a vehicular device attaching structure using the vehicular device attaching tools 400 and 420.

In the example shown in FIGS. 18A and 18B, the vehicular device attaching tool 400 is coupled on the top surface 130t side of the electronic key operation device 100, and the vehicular device attaching tool 420 is coupled on the bottom surface 130b side. Further, the fixing portion 401 of the vehicular device attaching tool 400 is fixed to the wall surface 621 of the glovebox 620 on the depth side by using the fasteners 408. Further, the fixing portion 421 of the vehicular device attaching tool 420 is fixed to a wall surface 622 of the glovebox 620 on the vehicle interior side by using a double-sided tape.

Also in the present embodiment, since the vehicular device attaching tools 400 and 420 are used in combination, and the coupling portions 402 and 422 are coupled to different positions among the fastening holes 161 to 164 and 171 to 174, the electronic key operation device 100 can be firmly held at a plurality of locations. Further, since the fixing portions 401 and 421 of the vehicular device attaching tools 400 and 420 are separated and fixed to the opposing surfaces of the glovebox 620, it is possible to restrain a vibration during traveling of the vehicle or an opening and closing operation of the glovebox 620 while securing the strength of fixation.

### Fifth Embodiment

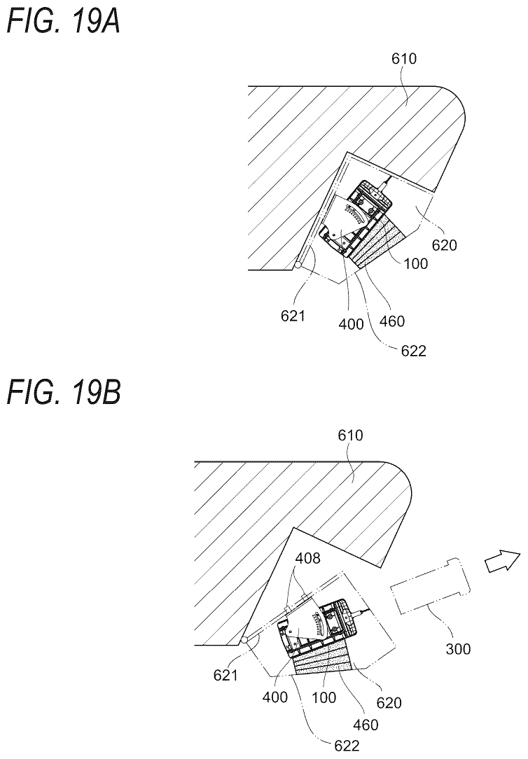

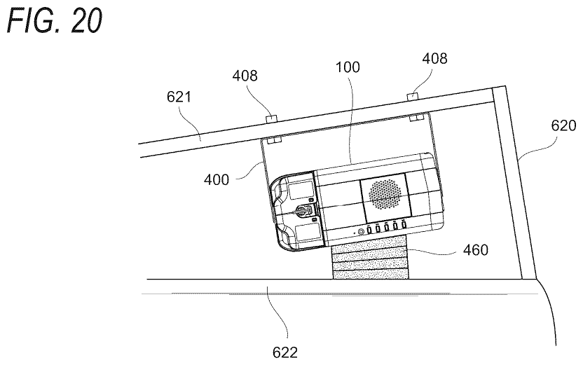

Next, a fifth embodiment according to the present invention will be described with reference to FIGS. 19A, 19B, and 20. Description of contents overlapping with the first embodiment will be omitted. The present embodiment is different from the first embodiment and the second embodiment in that a supporter 460 is used in addition to the vehicular device attaching tool 400.

FIGS. 19A and 19B are diagrams illustrating a vehicular device attaching structure using the vehicular device attaching tool 400 and the supporter 460. In the example shown in FIGS. 19A and 19B, the vehicular device attaching tool 400 is coupled on the top surface 130t side of the electronic key operation device 100, and the supporter 460 is arranged on the bottom surface 130b side. Further, the fixing portion 401 of the vehicular device attaching tool 400 is fixed to the wall surface 621 of the glovebox 620 on the depth side by using the fasteners 408. Further, the supporter 460 is in contact with the wall surface 622 of the glovebox 620 on the vehicle interior side.

The supporter 460 is arranged in contact with a different surface from the surfaces on which the fastening portions (the fastening holes 161 to 164 and 171 to 174) are arranged among the surfaces constituting the electronic key operation device 100, and is in contact with the mounting region of the vehicle. In the example shown in FIGS. 19A, 19B, and 20, the supporter 460 is provided in contact with the surface (the bottom surface 130b) opposite to the surface (the top surface 130t) on which the vehicular device attaching tool 420 is attached, and is arranged in contact with the wall surface 622 of the glovebox 620 on the vehicle interior side.

A material forming the supporter 460 is not limited, and by forming the supporter 460 with a material having a predetermined rigidity, the vehicular device attaching tool 400 can be assisted to more firmly attach the electronic key operation device 100 inside the glovebox 620. In addition, the vibration of the electronic key operation device 100 can be restrained even when an acceleration is applied to the electronic key operation device 100 during the traveling of the vehicle, the opening and closing operation of the glovebox 620, or the like.

Further, a member including an elastically deformable vibration absorbing portion may be used as the supporter 460. Here, examples of the elastically deformable vibration absorbing portion include a sponge-like member formed of a resin material, an air cushion obtained by sealing a gas in a bag-shaped member, a coil spring, and a plate spring. By using the supporter 460 including the elastically deformable vibration absorbing portion, it is possible to more effectively restrain the vibration of the electronic key operation device 100 even when the acceleration is applied to the electronic key operation device 100 during the traveling of the vehicle, the opening and closing operation of the glovebox 620, or the like.

FIG. 20 is a schematic diagram showing an example in which an elastically deformable vibration absorbing portion is used as the supporter 460. FIG. 20 shows the arrangement of the electronic key operation device 100, the vehicular device attaching tool 400, and the supporter 460 as viewed from an opening of the glovebox 620. A structure in which a plurality of sponge-like members formed of a resin are stacked is used as the supporter 460. Further, front and back surfaces of the sponge-like members may be laminated together by a double-sided tape or an adhesive. Further, the number of laminated sponge-like members may be adjusted according to a gap between the electronic key operation device 100 and the glovebox 620. In addition, the supporter 460 and the electronic key operation device 100 or the supporter 460 and the wall surface 622 may be laminated by using a double-sided tape or an adhesive.

In the example shown in FIG. 20, the wall surface 621 of the glovebox 620 on the depth side and the wall surface 622 thereof on the vehicle interior side are not parallel to each other, and the supporter 460 is elastically deformed and arranged to be sandwiched in the gap between the electronic key operation device 100 and the glovebox 620. Accordingly, the supporter 460 can be arranged independently of an interior shape of the glovebox 620, and the degree of freedom in installation of the supporter 460 can be improved.

Here, although an example in which the supporter 460 is arranged substantially in the center of the electronic key operation device 100 is shown, the arrangement of the supporter 460 is not limited, and the supporter 460 may be arranged on a side close to the right side surface 130r or the left side surface 130l. Further, the supporter 460 may be divided and arranged at a plurality of locations.

Embodiments and modifications of the present invention have been described above with reference to the drawings, but these embodiments and modifications are examples of the present invention, and various configurations other than those described above can also be used. The present invention is not limited to the embodiments described above, various modifications can be made within the scope of the claims, and embodiments obtained by appropriately combining technical methods disclosed in different embodiments are also included in the technical scope of the present invention.

According to the present specification, the following aspects are provided.

### Aspect 1

According to Aspect 1, there is provided a vehicular device attaching tool for attaching a vehicular device, which accommodates an electronic key of a vehicle, to the vehicle, the vehicular device attaching tool includes a fixing portion fixed to the vehicle; and a coupling portion extending from the fixing portion and coupled to the vehicular device, in which the coupling portion is formed with a center hole through which a first fastener is inserted, and an angle adjustment hole that has a predetermined length and through which a second fastener is inserted such that a fastening position is changeable.

According to Aspect 1, since the center hole and the angle adjustment hole are formed in the coupling portion, the vehicular device can be fixed to a mounting region of the vehicle at an appropriate angle.

### Aspect 2

According to Aspect 2, the angle adjustment hole is formed as a part of an arc centered at the center hole.

According to Aspect 2, by changing the fastening position in the angle adjustment hole, the electronic key operation device 100 can be held at various angles according to the vehicle type.

### Aspect 3

According to Aspect 3, the coupling portion has an overhang region deviating from the fixing portion in a plan view, and the center hole is formed in the overhang region.

According to Aspect 3, it is possible to improve the degree of freedom in installation by reducing a width of the fixing portion while ensuring a distance from the center hole formed in the overhang region to the angle adjustment hole.

### Aspect 4

According to Aspect 4, the vehicular device attaching tool further includes an additional coupling portion coupled to the vehicular device at a different position from the coupling portion, in which the additional coupling portion is formed with an additional adjustment hole that has a predetermined length and through which a third fastener is inserted such that a fastening position is changeable.

According to Aspect 4, it is possible to more firmly fix the vehicular device by coupling the vehicular device at the different position using the additional coupling portion.

### Aspect 5

According to Aspect 5, the fixing portion is formed separately from the coupling portion and the additional coupling portion.

According to Aspect 5, it is possible to improve the degree of freedom in installation of the additional coupling portion to the vehicle.

### Aspect 6

According to Aspect 6, an indicator portion indicating the fastening position is arranged along a length direction of the angle adjustment hole.

According to Aspect 6, the vehicular device and the vehicular device attaching tool can be easily coupled at an appropriate position in the angle adjustment hole for each vehicle type.

### Aspect 7

According to Aspect 7, there is provided a vehicular device attaching structure, the vehicular device attaching structure includes the vehicular device attaching tool according to any one of Aspect 1 to Aspect 6, the vehicular device, the first fastener, and the second fastener, in which the vehicular device includes a fastening portion to which the first fastener and the second fastener are fastened.

According to Aspect 7, by fastening the center hole and the angle adjustment hole to the fastening portion using the first fastener and the second fastener, the vehicular device can be fixed to the mounting region of the vehicle at an appropriate angle.

### Aspect 8

According to Aspect 8, the fastening portion includes at least four fastening holes formed in two opposing surfaces of the vehicular device, and the fastening holes are arranged to be vertically and laterally symmetric in the vehicular device.

According to Aspect 8, even when a fixing direction of the vehicular device with respect to the vehicle is changed, the vehicular device can be easily fixed by using the same vehicular device attaching tool, and the degree of freedom of installation can be improved. By adopting such a configuration, it is possible to attach the vehicular device to various positions inside a glovebox in various directions. As a result, it is possible to attach the above vehicular device having a certain size into gloveboxes of almost all automobiles, which are currently sold, without any problem.

### Aspect 9

According to Aspect 9, an identification portion for identifying each of the fastening holes is arranged in the vicinity of the fastening holes.

According to Aspect 9, it is possible to easily determine appropriate positions of the fastening holes for each vehicle type, and to fasten the center hole and the angle adjustment hole.

### Aspect 10

According to Aspect 10, the vehicular device attaching structure further includes a supporter arranged in contact with a surface of the vehicular device different from a surface on which the fastening portion is arranged.

According to Aspect 10, since the vehicular device is supported by the supporter in an auxiliary manner, the vehicular device can be fixed to the vehicle more firmly.

### Aspect 11

According to Aspect 11, the supporter includes an elastically deformable vibration absorbing portion.

According to Aspect 11, it is possible to restrain a vibration of the vehicular device that occurs during traveling of the vehicle or an opening and closing operation of the glovebox.

### Aspect 12

According to Aspect 12, there is provided a vehicular device attaching structure for attaching a vehicular device, which accommodates an electronic key of a vehicle, to the vehicle, the vehicular device attaching structure includes an attaching tool including a fixing portion fixed to the vehicle and a coupling portion extending from the fixing portion and coupled to the vehicular device; and a fastening portion fastened to the coupling portion formed in the vehicular device, in which the coupling portion is arranged on two opposing surfaces of the vehicular device, and the fastening portion is configured to allow fastening to the coupling portion even in a state in which a relation between the coupling portion and the two opposing surfaces of the vehicular device is relatively changed.

According to Aspect 12, since the fastening portion is configured to allow the fastening even in the state in which the relation between the two opposing surfaces of the vehicular device and the coupling portion of the attaching tool is relatively changed, it is possible to provide a vehicular device attaching structure in which the degree of freedom in attachment of the vehicular device to the vehicle is improved.

### REFERENCE SIGNS LIST

5: vehicle
100: electronic key operation device
161 to 164, 171 to 174: fastening hole
165 to 168, 175 to 178: identification portion
200: electronic key
400, 410, 420, 430, 440, 450: vehicular device attaching tool
401, 411, 421, 431a, 431b, 441a, 441b, 451a, 451b: fixing portion
402, 412, 432a, 432b, 442a, 442b: coupling portion
422, 452a, 452b: additional coupling portion
402b, 412b: overhang region
403, 413, 433a, 433b, 443a, 443b: fixing hole
404, 414, 434a, 434b, 444a, 444b: center hole
405, 415, 435a, 435b, 445a, 445b: angle adjustment hole
425, 455a, 455b: additional adjustment hole
406, 416, 426, 436a, 436b, 446a, 446b, 456a, 456b: indicator portion
407a, 417a: first fastener
407b, 417b: second fastener
427: third fastener
460: supporter

1. A vehicular device attaching tool for attaching a vehicular device, which accommodates an electronic key of a vehicle, to the vehicle, comprising:
a fixing portion fixed to the vehicle; and
a coupling portion extending from the fixing portion and coupled to the vehicular device, wherein
the coupling portion is formed with a center hole through which a first fastener is inserted, and an angle adjustment hole that has a predetermined length and through which a second fastener is inserted such that a fastening position is changeable.

2. The vehicular device attaching tool according to claim 1, wherein the angle adjustment hole is formed as a part of an arc centered at the center hole.

3. The vehicular device attaching tool according to claim 1, wherein
the coupling portion has an overhang region deviating from the fixing portion in a plan view, and
the center hole is formed in the overhang region.

4. The vehicular device attaching tool according to claim 1, further comprising:
an additional coupling portion coupled to the vehicular device at a different position from the coupling portion, wherein
the additional coupling portion is formed with an additional adjustment hole that has a predetermined length and through which a third fastener is inserted such that a fastening position is changeable.

5. The vehicular device attaching tool according to claim 4, wherein
the fixing portion is formed separately from the coupling portion and the additional coupling portion.

6. The vehicular device attaching tool according to claim 1, wherein
an indicator portion indicating the fastening position is arranged along a length direction of the angle adjustment hole.

7. A vehicular device attaching structure, comprising the vehicular device attaching tool according to claim 1;
the vehicular device;
the first fastener; and
the second fastener, wherein
the vehicular device includes a fastening portion to which the first fastener and the second fastener are fastened.

8. The vehicular device attaching structure according to claim 7, wherein
the fastening portion includes at least four fastening holes formed in two opposing surfaces of the vehicular device, and
the fastening holes are arranged to be vertically and laterally symmetric in the vehicular device.

9. The vehicular device attaching structure according to claim 8, wherein
an identification portion for identifying each of the fastening holes is arranged in the vicinity of the fastening holes.

10. The vehicular device attaching structure according to claim 8, further comprising:
a supporter arranged in contact with a surface of the vehicular device different from a surface on which the fastening portion is arranged.

11. The vehicular device attaching structure according to claim 10, wherein
the supporter includes an elastically deformable vibration absorbing portion.

12. A vehicular device attaching structure for attaching a vehicular device, which accommodates an electronic key of a vehicle, to the vehicle, comprising:
an attaching tool including a fixing portion fixed to the vehicle and a coupling portion extending from the fixing portion and coupled to the vehicular device; and
a fastening portion fastened to the coupling portion formed in the vehicular device, wherein
the coupling portion is arranged on two opposing surfaces of the vehicular device, and
the fastening portion is configured to allow fastening to the coupling portion even in a state in which a relation between the coupling portion and the two opposing surfaces of the vehicular device is relatively changed.
